(19) United States
(12) Patent Application Publication
(10) Pub. No.: US 2025/0095916 A1
(43) Pub. Date: Mar. 20, 2025

(54) RARE EARTH MAGNET, METHOD FOR MANUFACTURING THE SAME, AND MOTOR INCLUDING THE SAME

(71) Applicant: TOYOTA JIDOSHA KABUSHIKI KAISHA, Toyota-shi (JP)

(72) Inventors: Tetsuya SHOJI, Sunto-gun (JP); Akihito KINOSHITA, Mishima-shi (JP); Noritsugu SAKUMA, Mishima-shi (JP)

(73) Assignee: TOYOTA JIDOSHA KABUSHIKI KAISHA, Toyota-shi (JP)

(21) Appl. No.: 18/819,310

(22) Filed: Aug. 29, 2024

(30) Foreign Application Priority Data
Sep. 20, 2023 (JP) 2023-152042

(51) Int. Cl. H01F 41/02; H02K 1/02; H02K 1/27

(52) U.S. Cl. CPC H01F 41/0293; H02K 1/02; H02K 1/27

(57) ABSTRACT

Provided is an R-T-B-based rare earth magnet with an excellent magnetic property while ensuring a dimensional accuracy. The present disclosure relates to an R-T-B-based rare earth magnet in which R is a rare earth element, T is Fe and/or Co, and B is boron. The R-T-B-based rare earth magnet includes a magnet region layer and a surface layer covering a C-plane of the magnet region layer. The magnet region layer includes a main phase having an R₂T₁₄B-type crystal structure and a grain boundary phase present around the main phase. The main phase has an average grain size from 1.0 μm to 10.0 μm. The surface layer covers 85% or more of the C-plane of the magnet region layer with respect to a total area of the C-plane.

### CROSS REFERENCE TO RELATED APPLICATIONS

The present application claims priority from Japanese patent application JP 2023-152042 filed on Sep. 20, 2023, the entire content of which is hereby incorporated by reference into this application.

### BACKGROUND

### Technical Field

The present disclosure relates to a rare earth magnet, a method for manufacturing the same, and a motor including the same.

### Background Art

In recent years, Sm—Co-based rare earth magnets and R-T-B-based permanent magnets, such as Nd—Fe—B-based rare earth magnets, have been commercialized as high-performance rare earth magnets.

For example, JP 2018-82145 A discloses a method for manufacturing a sintered R—Fe—B-based magnet including: (1) manufacturing a sintered R—Fe—B-based magnet using a known method; (2) removing oil, washing using an acid solution, activating, and washing using deionized water on the sintered magnet; (3) mixing a superfine terbium powder, an organic solvent, and an antioxidant to prepare a homogeneous slurry, and then coating the homogeneous slurry on a surface of the sintered magnet processed in the (2); and (4) sintering and aging the magnet in the (3).

JP 2020-21804 A discloses a sintered magnet including grains having a main phase in which a main component is a compound containing a rare-earth element and iron and a diffusion layer provided on a surface of the main phase. The diffusion layers contain a compound resulting from a solid-solution of at least one of carbon and/or nitrogen in the compound of the main phase and having a concentration gradient of at least one of carbon and/or nitrogen from the surfaces of the grains toward interiors thereof.

JP 2020-57734 A discloses a sintered R—Fe—B-based magnet in which a multi-layer main phase grain having multiple layers including a layer 1 having R² concentration, which is a specific element in R represented by at %, higher than a concentration of a center of the grain, a layer 2 formed on an outside of the layer 1 and having the R² concentration lower than the concentration of the layer 1, and a layer 3 formed on a further outside of the layer 2 and having the R² concentration higher than the concentration of the layer 2 is present at least in a part in a vicinity of a surface of the main phase grain within at least 500 μm from a surface of a sintered magnet body.

### SUMMARY

Recently, in motors used for electric vehicles and the like, a quality related to heat resistance is ensured by diffusing a rare earth element from surfaces of magnets in the motor to make the magnets highly coercive and reduce the heavy rare earth elements. In general, the obtained magnets expand after the rare earth elements are diffused, thus, the magnets must be polished to ensure the dimensions of the final magnet, and then a coating must be formed on the magnets, either by forming a resin film or by plating.

However, the inventors have found that when magnets, especially sintered magnets, are polished, there is an exposed main phase on the magnet surface that is not surrounded by a grain boundary phase that is rich in the rare earth elements. The grains in the main phase can cause a loss of magnet performance, especially coercive force (Hc), and cause demagnetization at low magnetic fields. As a result, the obtained magnets possibly lead to a decrease in coercive force and residual magnetization (knick).

Therefore, the present disclosure provides an R-T-B-based rare earth magnet with an excellent magnetic property while ensuring a dimensional accuracy.

As a result of various examinations of means to solve the aforementioned problems, the inventors have completed the present disclosure by finding that, in a NdFeB-based rare earth magnet with grain boundary diffusion from both C-planes, by carrying out limited polishing after the grain boundary diffusion, the dimensional accuracy of the obtained NdFEB-based rare earth magnet when inserted in a rotor can be secured while the coercive force is allowed to be maintained at the same time.

In other words, the gist of the present disclosure is as follows.
(1) An R-T-B-based rare earth magnet in which R is a rare earth element, T is iron (Fe) and/or cobalt (Co), and B is boron comprises: a magnet region layer; and a surface layer covering a C-plane of the magnet region layer. The magnet region layer includes a main phase having an R₂T₁₄B-type crystal structure and a grain boundary phase present around the main phase. The main phase has an average grain size from 1.0 μm to 10.0 μm. The surface layer covers 85% or more of the C-plane of the magnet region layer with respect to a total area of the C-plane.
(2) In the R-T-B-based rare earth magnet according to (1), the main phase includes a core portion and a shell portion present around the core portion, and a total content ratio of neodymium (Nd), praseodymium (Pr), terbium (Tb), dysprosium (Dy), and holmium (Ho) to a total of constituent elements of the shell portion in the shell portion is higher than a total content ratio of Nd, Pr, Tb, Dy, and Ho to a total of constituent elements of the core portion in the core portion.
(3) In the R-T-B-based rare earth magnet according to (1) or (2), a composition of the surface layer and the grain boundary phase is represented by Formula of R²₍₁₋ₛ₎ M²ₛ (in the formula, R² is one or more elements selected from the group consisting of Nd, Pr, Gd, Tb, Dy, cerium (Ce), lanthanum (La), and Ho, M² is a metallic element other than rare earth elements and allowed to be alloyed with R² and an unavoidable impurity elements, and (1-s) and s are molar ratios where 0.05≤s≤0.40).
(4) In the R-T-B-based rare earth magnet according to any one of (1) to (3), a rare earth concentration of the surface layer is higher than a rare earth concentration of the magnet region layer.
(5) A motor comprises a stator core including a coil and a rotor core rotatable in a hollow portion of the stator core. The rotor core includes the R-T-B-based rare earth magnet according to any one of (1) to (4).
(6) A method for manufacturing an R-T-B-based rare earth magnet in which R is a rare earth element, T is Fe and/or Co, and B is boron comprises: preparing a diffusion material penetrated rare earth magnet precursor having a magnet region layer and a surface layer covering a C-plane of the magnet region layer by diffusive penetration of a diffusion material into a rare earth magnet precursor; and manufacturing an R-T-B-based rare earth magnet by polishing the diffusion material penetrated rare earth magnet precursor. In the preparing, the diffusion material is represented by Formula of R²₍₁₋ₛ₎M²ₛ (in the formula, R² is one or more elements selected from the group consisting of Nd, Pr, Gd, Tb, Dy, Ce, La, and Ho, M² is a metallic element other than rare earth elements and allowed to be alloyed with R² and an unavoidable impurity elements, and (1-s) and s are molar ratios where 0.05≤s≤0.40), the diffusion material penetrated rare earth magnet precursor includes a main phase having an R₂T₁₄B-type crystal structure and a grain boundary phase present around the main phase, and the main phase has an average grain size from 1.0 μm to 10.0 μm. In the manufacturing, the surface layer present on the C-plane of the diffusion material penetrated rare earth magnet precursor is polished such that 85% or more of a total area of the C-plane of the diffusion material penetrated rare earth magnet precursor remains.
(7) A method for manufacturing an R-T-B-based rare earth magnet in which R is a rare earth element, T is Fe and/or Co, and B is boron comprises: preparing a diffusion material penetrated rare earth magnet precursor having a magnet region layer and a surface layer covering a C-plane of the magnet region layer by diffusive penetration of a diffusion material into a rare earth magnet precursor; and manufacturing an R-T-B-based rare earth magnet by polishing the diffusion material penetrated rare earth magnet precursor. In the preparing, the diffusion material is represented by Formula of R²₍₁₋ₛ₎M²ₛ (in the formula, R² is one or more elements selected from the group consisting of Nd, Pr, Gd, Tb, Dy, Ce, La, and Ho, M² is a metallic element other than rare earth elements and allowed to be alloyed with R² and an unavoidable impurity elements, and (1-s) and s are molar ratios where 0.05≤s≤0.40), the diffusion material penetrated rare earth magnet precursor includes a main phase having an R₂T₁₄B-type crystal structure and a grain boundary phase present around the main phase, and the main phase has an average grain size from 1.0 μm to 10.0 μm. In the manufacturing, the diffusion material penetrated rare earth magnet precursor is polished to less than a thickness of the surface layer expressed by a following formula of use amount of the diffusion material (amount of diffusion material to a total weight of the rare earth magnet precursor (weight %, wt %))×2.2172.

With the present disclosure, an R-T-B-based rare earth magnet with an excellent magnetic property while ensuring a dimensional accuracy can be provided.

### BRIEF DESCRIPTION OF THE DRAWINGS

FIG. 1 is a view schematically illustrating polished regions in Example and Comparative Example;

FIG. 2A is a graph illustrating a relationship between a polished region and a coercive force in a sintered magnet;

FIG. 2B is a graph illustrating a relationship between a polished region and a coercive force in a hot-worked magnet;

FIG. 3 is a view schematically illustrating expansions of the magnets and slotting in of the magnets into a rotor;

FIG. 4 is a SEM photograph of a magnet region layer and a surface layer of an unpolished portion in a magnet in Example 1;

FIG. 5 is a graph illustrating a relationship between use amount of a diffusion material (diffusion amount) and average thickness of the surface layer; and

FIG. 6 schematically illustrates parts of the magnet of Example and Comparative Example.

### DETAILED DESCRIPTION

The following describes some embodiments of the present disclosure in detail. In the present description, features of the present disclosure will be described with reference to the drawings as necessary. In the drawings, dimensions and shapes of respective components are exaggerated for clarification, and actual dimensions and shapes are not accurately illustrated. Accordingly, the technical scope of the present disclosure is not limited to the dimensions and the shapes of the respective components illustrated in these drawings. Note that a rare earth magnet, a method thereof, and a motor including the same of the present disclosure is not limited to the embodiments below, and can be performed in various configurations in which changes, improvements, and the like that a person skilled in the art can make are given without departing from the gist of the present disclosure.

In an R-T-B-based rare earth magnet of the present disclosure, R is a rare earth element, for example, one or more selected from the group consisting of Ce, La, yttrium (Y), scandium (Sc), Nd, Pr, gadolinium (Gd), Tb, Dy, and Ho. T is an iron group element and is Fe, Co, or Fe and Co (Fe and/or Co). The ratio of each element in the case of Fe and Co is not limited here. Furthermore, B is boron. The R-T-B-based rare earth magnets of the present disclosure may contain an additive element known in the art, for example, one or more selected from the group consisting of titanium, vanadium, copper, chromium, manganese, nickel, zirconium, niobium, molybdenum, hafnium, tantalum, tungsten, aluminum, gallium, silicon, bismuth, tin, and the like, as long as a coercive force of the R-T-B-based rare earth magnet is not compromised.

In the R-T-B-based rare earth magnet of the present disclosure, the content of R is usually 10 at % to 20 at % of the total atomic number of the R-T-B-based rare earth magnet. In one embodiment, in R, the content of Nd is usually 8 at % to 20 at % of the total atomic number of the R-T-B-based rare earth magnet. In one embodiment, in R, the content of Pr is usually 1 at % to 10 at % of the total atomic number of the R-T-B-based rare earth magnet. In the R-T-B-based rare earth magnet of the present disclosure, the content of T is 70 at % to 85 at % of the total atomic number of the R-T-B-based rare earth magnet. In one embodiment, in T, the content of Fe is usually 70 at % to 85 at % of the total atomic number of the R-T-B-based rare earth magnet. In one embodiment, in T, the content of Co is usually 1 at % to 10 at % of the total atomic number of the R-T-B-based rare earth magnet. In the R-T-B-based rare earth magnet of the present disclosure, the content of B is usually 5 at % to 20 at % of the total atomic number of the R-T-B-based rare earth magnet. In the R-T-B-based rare earth magnet of the present disclosure, the content of additive element is usually 0 at % to 2 at % of the total atomic number of the R-T-B-based rare earth magnet. In one embodiment, the content of Ga is usually 0 at % to 1.0 at % of the total atomic number of the R-T-B-based rare earth magnet. In one embodiment, the content of Cu is usually 0 at % to 0.5 at % of the total atomic number of the R-T-B-based rare earth magnet. In one embodiment, the content of Al is usually 0 at % to 0.2 at % of the total atomic number of the R-T-B-based rare earth magnet. The content of each element in the R-T-B-based rare earth magnet may be calculated based on the amount of each element added in the manufacturing, or the content may be measured using a method known in the art, such as an X-ray fluorescence analysis (XRF), an inductively coupled plasma mass spectrometry (ICP-MS), an inductively coupled plasma atomic emission spectrometry (ICP-AES), or the like.

The R-T-B-based rare earth magnets composed of the above-described elements are allowed to have a high coercive force.

The R-T-B-based rare earth magnets of the present disclosure have a magnet region layer and a surface layer.

The magnet region layer has a main phase having an R₂T₁₄B-type crystal structure and a grain boundary phase present around the main phase. Crystals having the R₂T₁₄B-type crystal structure, which constitute the main phase, are bonded to one another through the grain boundary phase. In other words, the main phase is separated by the grain boundary phase and is also separated magnetically, suppressing magnetization reversal and allowing it to have a higher coercive force compared with a case in which the main phase is not separated by the grain boundary phase.

The average grain size of the main phase is 1.0 μm to 10.0 μm, and 2 μm to 6 μm in one embodiment.

Here, “average grain size” is measured as follows. With the scanning electron microscope image or the transmission electron microscope image, a fixed region observed from a perpendicular direction of an easy axis of magnetization is defined, multiple lines are drawn perpendicular to the easy axis of magnetization for the main phase present within this fixed region, and the diameter (length) of the main phase is calculated from a distance between points that intersect in the grain of the main phase (cutting method). When the cross section of the main phase is close to a circle, it is converted using a projected area circle equivalent diameter. When the cross section of the main phase is close to a rectangle, it is converted using a rectangular approximation. The D50 value of the diameter (length) distribution (grain size distribution) obtained in this way is the average grain size.

The coercive forces of the rare earth magnets having the average grain size of the main phase in the above range are allowed to improve.

In one embodiment, the main phase has a core portion and a shell portion present around the core portion.

The average grain size of the core portion of the main phase is usually from 0.4 μm to 9.99 μm. The average thickness of the shell portion of the main phase is usually from 5 nm to 300 nm. The grain size of the core portion is equivalent to the grain size of the main phase minus a double of the thickness of the shell portion.

Here, the average thickness of the shell portion of the main phase can be measured as a composition modulated portion from the core portion by TEM-EDX analysis or the like.

In the main phase, a total content ratio of Ce, La, Gd, Y, and Sc to a total of constituent elements of the core portion in the core portion is higher than a total content ratio of Ce, La, Gd, Y, and Sc to a total of constituent elements of the shell portion in the shell portion. For example, the ratio (ratio of core portion to shell portion) of the total content ratio of Ce, La, Gd, Y, and Sc to the total of constituent elements of the core portion (for example, ratio in amount of substance (moles)) in the core portion to the total content ratio of Ce, La, Gd, Y, and Sc to the total of constituent elements of the shell portion (for example, ratio in amount of substance (moles)) in the shell portion is usually 1.1:1 to 10:1.

In the main phase, a total content ratio of Nd, Pr, Tb, Dy, and Ho to a total of constituent elements of the shell portion in the shell portion is higher than a total content ratio of Nd, Pr, Tb, Dy, and Ho to a total of constituent elements of the core portion in the core portion. For example, the ratio (ratio of shell portion to core portion) of the total content ratio of Nd, Pr, Tb, Dy, and Ho to the total of constituent elements of the shell portion (for example, ratio in amount of substance (moles)) in the shell portion to the total content ratio of Nd, Pr, Tb, Dy, and Ho to the total of constituent elements of the core portion (for example, ratio in amount of substance (moles)) in the core portion is usually 1.01:1 to 10:1.

It is possible to increase a residual magnetization and a coercive force of an entire rare earth magnet by increasing the residual magnetization and the coercive force in the shell portion than increasing the residual magnetization and coercive force in the core portion. The residual magnetization and the coercive force increase with increasing the content ratios of Nd, Pr, Tb, Dy, and Ho. Thus, Ce, La, Gd, Y, and Sc in the rare earth magnet precursor are ejected from the shell portion into the grain boundary phase by diffusive penetration of the diffusion material while Nd, Pr, Tb, Dy, and Ho in the diffusion material are diffusively penetrated from the grain boundary phase into the shell portion, which is advantageous for improving the residual magnetization and the coercive force.

In one embodiment, the composition of the grain boundary phase is represented by Formula of R²₍₁₋ₛ₎M²ₛ (in the formula, R² is one or more elements selected from the group consisting of Nd, Pr, Gd, Tb, Dy, Ce, La, and Ho, M² is a metallic element other than rare earth elements and allowed to be alloyed with R² and an unavoidable impurity elements, and (1-s) and s are molar ratios where 0.05≤s≤0.40). The composition of the grain boundary phase depends on the composition of the diffusion material in the method for manufacturing the R-T-B-based rare earth magnets described below.

The surface layer is a layer formed on a C-plane of the magnet region layer.

The C-plane is a plane perpendicular to a c-axis, that is, an easy direction of magnetization, in the magnet region layer.

In the R-T-B-based rare earth magnets of the present disclosure, similarly to the grain boundary phase, the composition of the surface layer is represented by Formula of R²₍₁₋ₛ₎M²ₛ (in the formula, R² is one or more elements selected from the group consisting of Nd, Pr, Gd, Tb, Dy, Ce, La, and Ho, M² is a metallic element other than rare earth elements and allowed to be alloyed with R² and an unavoidable impurity elements, and (1-s) and s are molar ratios where 0.05≤s≤0.40). The composition of the surface layer depends on the composition of the diffusion material in the method for manufacturing the R-T-B-based rare earth magnets described below.

In the R-T-B-based rare earth magnets of the present disclosure, the average thickness of the surface layer can be adjusted by the use amount of the diffusion material in the manufacturing, as described below, and is usually from 1 μm to 50 μm, or from 3 μm to 30 μm in one embodiment. Here, the “average thickness of the surface layer” is an average value of thicknesses of the surface layer at locations where the surface layer has not been removed by polishing and is present. The average thickness of the surface layer can be measured as a composition modulated portion from the magnet region layer by TEM-EDX analysis or the like.

In the R-T-B-based rare earth magnets of the present disclosure, the surface layer covers the C-plane of the magnet region layer by 85% or more, or in one embodiment, 87% or more of the total area of the C-plane. The percentage of the surface layer covering the C-plane of the magnet region layer may be 100%, 99% or less in one embodiment, and 98% or less in one embodiment.

In other words, in the R-T-B-based rare earth magnets of the present disclosure, an area of a part present in the C-plane of the R-T-B-based rare earth magnet where the surface layer is not present and the main phase is exposed is 15% or less of the total area of the C-plane of the R T-B-based rare earth magnet, and 13% or less of the total area of the C-plane of the R-T-B-based rare earth magnet in one embodiment. The area of the part present in the C-plane of the R-T-B-based rare earth magnet where the surface layer is not present and the main phase is exposed may be 0%, 1% or more in one embodiment, and 2% or more in one embodiment.

In the R-T-B-based rare earth magnets of the present disclosure, the area of the main phase exposed on the C-plane due to the absence of the surface layer is suppressed to be equal to or below a certain value. This causes the grain boundary phases with high concentration of the rare earths to be present around the main phase. Thus, the magnetization reversal and the decrease in the coercive force of the entire magnet caused by the main phase in the grains with low coercive force can be suppressed.

The shape of the R-T-B-based rare earth magnet of the present disclosure is not particularly limited. The shape of the R-T-B-based rare earth magnet of the present disclosure can take any shape, for example, a rectangular body, a hexahedron, a flat plate, a column shape such as a square pillar, or a cylindrical shape with a C-shaped cross section of the R-T-B-based rare earth magnet.

The R-T-B-based rare earth magnets of the present disclosure include both magnet products in which the magnet is magnetized after processing and magnet products in which the magnet is not magnetized.

The R-T-B-based rare earth magnets of the present disclosure having the above-described configuration and composition allows the R-T-B-based rare earth magnets of the present disclosure to have the high coercive force.

The R-T-B-based rare earth magnet of the present disclosure can be manufactured using known techniques in the art except for preparing a rare earth magnet precursor and a diffusion material corresponding to the composition of the surface layer and the grain boundary phase to achieve the configuration and the composition of the R-T-B-based rare earth magnet of the present disclosure and performing a first step and a second step. The first step prepares a diffusion material penetrated rare earth magnet precursor having a magnet region layer and a surface layer covering the magnet region layer by diffusive penetration of the diffusion material in the rare earth magnet precursor during the grain boundary diffusion. The second step polishes the diffusion material penetrated rare earth magnet precursor.

The R-T-B-based rare earth magnets of the present disclosure can be manufactured, for example, as follows.

In the rare earth magnet precursor of R-T-B-based rare earth magnet, molten of a predetermined composition is first cooled at a rate at which the average grain size of the main phase (R₂T₁₄B phase) becomes 1.0 μm to 10.0 μm, to obtain a magnetic ribbon. Such cooling rate is, for example, 1° C./s to 1000° C./s. Examples of methods to obtain magnetic powder at such a cooling rate include a strip casting method and a book molding method. The composition of the molten is basically the same as the overall composition of the rare earth magnet precursor, but for elements that may be depleted in the process of manufacturing the rare earth magnet precursor, such depletion may be accounted for.

The magnetic powder made by pulverizing the above-mentioned magnetic ribbon is compacted. The compacting may be performed in a magnetic field. This can impart anisotropy to the rare earth magnets after sintering. The molding pressure during compacting may be, for example, 50 MPa or more, 100 MPa or more, 200 MPa or more, or 300 MPa or more, and may be 1000 MPa or less, 800 MPa or less, or 600 MPa or less. The applied magnetic field may be 0.1 T or more, 0.5 T or more, 1 T or more, 1.5 T or more, or 2.0 T or more, and may be 10.0 T or less, 8.0 T or less, 6.0 T or less, or 4.0 T or less. The method for pulverizing includes, for example, coarsely pulverizing the magnetic ribbon and then further pulverizing it in a jet mill or the like. The method for coarsely pulverizing includes, for example, a method using a hammer mill and a method of hydrogen embrittlement of the magnetic ribbon, and a combination thereof.

The above-described green compact is then subjected to pressureless sintering to obtain a rare earth magnet precursor. The green compact is sintered at a high temperature for a long time in order to increase the density of a sintered body by pressureless sintering. The sintering temperature may be, for example, 900° C. or higher, 950° C. or higher, or 1000° C. or higher, and may be 1100° C. or lower, 1050° C. or lower, or 1040° C. or lower. The sintering time may be, for example, 1 hour or more, 2 hours or more, 3 hours or more, or 4 hours or more, and may be 24 hours or less, 18 hours or less, 12 hours or less, or 6 hours or less. In some embodiments, an inert gas atmosphere is used for the sintering atmosphere to suppress oxidation of the green compact during sintering. The inert gas atmosphere includes a nitrogen gas atmosphere.

Subsequently, the diffusion material described below is then diffusively penetrated into the rare earth magnet precursor to manufacture diffusion material penetrated rare earth magnets.

### First Step (Diffusive Penetration)

A diffusion material is diffusively penetrated into the rare earth magnet precursor. Thereby, the coercive forces of the rare earth magnets of the present disclosure, especially the coercive forces at high temperatures, can be advantageously improved.

In the diffusive penetration of diffusion material, a diffusion material is prepared and the diffusion material is diffusively penetrated into the rare earth magnet precursor. With respect to the total of constituent elements of the diffusion material, the diffusion material contains 60 at % to 95 at %, or 65 at % to 80 at % in one embodiment, of one or more elements selected from the group consisting of Nd, Pr, Gd, Tb, Dy, Ce, La and Ho, contains 5 at % to 30 at %, or 15 at % to 25 at % in one embodiment, of one or more elements selected from the group consisting of Fe and Co, and contains 5 at % to 20 at %, or 5 at % to 15 at % in one embodiment, of one or more elements selected from the group consisting of fluorine, gallium, aluminum, and copper.

Examples of methods of preparing the diffusion material include: a method of obtaining a ribbon and/or flakes, or the like from a molten having the composition of the diffusion material, using a liquid quenching method, a strip casting method, or the like; a method of casting molten having the composition of the diffusion material in a mold such as a book mold; and a method of charging raw materials of the diffusion material into a vessel, arc-melting the raw materials in the vessel, and cooling the molten material to obtain an ingot.

The prepared diffusion material is diffusively penetrated into the rare earth magnet precursor. As a method of the diffusive penetration, typically, the diffusion material is brought into contact with the rare earth magnet precursor to obtain a contact body, which is then heated to diffusively penetrate a diffusion material melt into the rare earth magnet precursor. The diffusion material melt diffusively penetrates through the grain boundary phase. The diffusion material melt solidifies in the grain boundary phase and magnetically separates the main phases, resulting in an advantageous increase in the coercive force, especially the coercive force at high temperatures.

There are no restrictions on the form of the contact body, as long as the diffusion material is in contact with the rare earth magnet precursor. As the form of the contact body, for example, the contact body may be manufactured by bringing the rare earth magnet precursor into contact with the diffusion material in a ribbon and/or flakes obtained by liquid quenching and/or strip casting method. As the form of the contact body, for example, the contact body may be manufactured by bringing the rare earth magnet precursor into contact with a diffusion material powder manufactured by pulverizing the ribbon and/or flakes obtained by liquid quenching method and/or strip casting method, book mold material, or arc melt solidification material.

There are no restrictions on the diffusive penetration conditions, as long as the diffusion material diffusively penetrates into the rare earth magnet precursor, the main phase does not coarsen, and the formation of detrimental phases that adversely affect the magnetic properties can be suppressed.

The diffusive penetration temperature is, for example, usually 800° C. to 1000° C. The diffusive penetration time is usually 30 to 300 minutes. After the diffusive penetration of the diffusion material, the sintered body is cooled quickly in some embodiments. This can suppress the formation of detrimental phases that adversely affect the magnetic properties. The cooling rate is, for example, usually 10° C./min to 1000° C./min. In order to suppress oxidation of the rare earth magnet precursor during the diffusive penetration, an inert gas atmosphere is used for the diffusive penetration atmosphere in some embodiments. The inert gas atmosphere includes a nitrogen gas atmosphere.

Upon the diffusive penetration of the diffusion material, 0.1 parts by weight to 15.0 parts by weight, or in one embodiment, 5 parts by weight to 10 parts by weight of the diffusion material are brought into contact with the rare earth magnet precursor for 100 parts by weight of the rare earth magnet precursor.

In order to diffusively penetrate the diffusion material under conditions where the main phase of the rare earth magnet precursor does not coarsen, the average grain size of the main phase before the diffusive penetration of the diffusion material and the average grain size of the main phase after the diffusive penetration of the diffusion material are in the sizes of substantially the same range. The average grain size and the crystal structure of the main phase are as described above.

In some embodiments, an inert gas atmosphere is used for the diffusive penetration atmosphere to suppress the oxidation of the rare earth magnet precursor and the diffusion material during the diffusive penetration of the diffusion material. The inert gas atmosphere includes a nitrogen gas atmosphere.

### Second Step (Polishing)

The obtained diffusion material penetrated rare earth magnet precursor is then polished.

The polishing of the diffusion material penetrated rare earth magnet precursor is performed such that the surface layer present in the C-plane of the diffusion material penetrated rare earth magnet precursor remains 85% or more, and in one embodiment 87% or more of the total area of the C-plane of the diffusion material penetrated rare earth magnet precursor. Alternatively, the polishing of the diffusion material penetrated rare earth magnet precursor is performed within 15% or less of the total area of the C-plane of the diffusion material penetrated rare earth magnet precursor, and within the area of 13% or less in one embodiment.

Alternatively, the polishing of the diffusion material penetrated rare earth magnet precursor is performed toless than the thickness of the surface layer represented by the following formula, that is, the surface layer remains on the C-plane of the diffusion material penetrated rare earth magnet precursor.

Use amount of the diffusion material (Amount of the diffusion material with respect to the total weight of rare earth magnet precursor (weight %))×2.2172

By polishing the diffusion material penetrated rare earth magnet precursor as described above, the area of the main phase exposed on the C-plane due to the absence of the surface layer is suppressed to be equal to or below a certain value, and a grain boundary phase with high rare earth concentration is present around the main phase. This suppresses the magnetization reversal and the decrease in the coercive force of the entire magnet caused by the main phase in the grains with low coercive force.

The R-T-B-based rare earth magnets of the present disclosure can be provided in motors known in the art. Accordingly, the present disclosure also relates to a motor including a stator core with a coil and a rotor core rotatably provided in a hollow portion of the stator core in which the rotor core includes the R-T-B-based rare earth magnets of the present disclosure.

### Examples

The following is a description of some examples of the present disclosure, which is not intended to limit the present disclosure to those shown in the examples.

1. Grain Boundary Diffusion into Sintered Magnet and Polishing Area

### 1-1. Manufacturing of the Rare Earth Magnets

The rare earth magnets were manufactured as follows, based on the description of the method for manufacturing the rare earth magnets described above.

First, for a sintered magnet with a composition of Nd_{11.3}, Pr_{2.7}, Fe_{balance}, Co_{1.1}, B_{5.9}, Ga_{0.4}, Al_{0.2}, Cu_{0.2} (the numbers are in at %, and when all the elements are added together, the number becomes 100 at %), a diffusion material with a composition of Tb₂₀Nd₆₀Cu₂₀ (the numbers are in at %, and when all the elements are added together, the number becomes 100 at %) was grain-boundary diffused into the sintered magnet from the C-plane direction (950° C., 165 min.) in an amount of 6 weight % of the total weight of the sintered magnet.

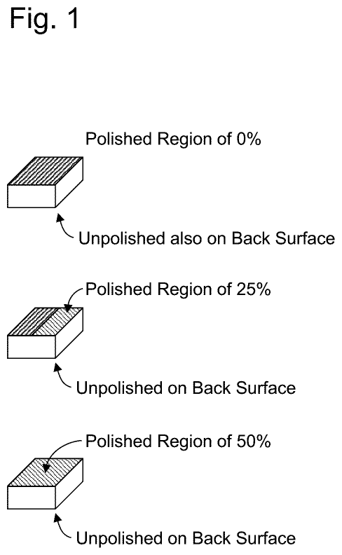

After the grain boundary diffusion, a part of the C-plane was polished to the extent that the surface layer (residue) of the diffusion material was scraped away. The polished region was varied from the polished region of 0% (no polishing) to the polished region of 50% (the entire surface of one side), as shown in FIG. 1.

After the polishing was completed, the magnetic properties were evaluated by VSM. The crystal grain sizes of the magnets (the average grain size of the main phase) were observed by SEM.

### 1-2. Results

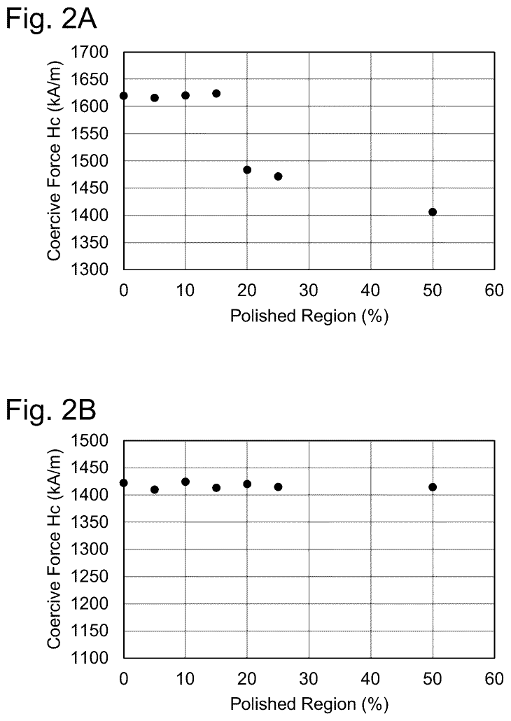

Table 1 and FIG. 2A show the results of the magnetic property evaluation. In the table, “average grain size” indicates the average grain size of the main phase, and the same applies to the following tables.

TABLE 1
Table 1 Grain Boundary Diffusion [symbol] nto Sintered Magnet and Polishing Area

| | Composition | | | | | | | | | | Residual |
|---|---|---|---|---|---|---|---|---|---|---|---|
| | of Base | Magnet | Average | | Both | | | | Polished | Coercive | Magne- |
| | Material | Production | Grain | Diffusion | Sides/ | Diffusion | Diffusion | Polished or | Region | Force | tization |
| | (at %) | Method | Size | Material | One Side | Temperature | Time | Unpolished | (%) | (kA/m) | (T) |
| Comparative | [symbol] | Sintered | 4.9 μm | — | — | — | — | — | — | [symbol] | 1.40 |
| Example 1 | | Magnet | | | | | | | | | |
| Example 1 | [symbol] | Sintered | 4.9 μm | [symbol] | Both Sides | 950° C. | 165 min. | Unpolished | 0 | [symbol] | 1.37 |
| | | Magnet | | 6 wt % | | | | | | | |
| Example 2 | [symbol] | Sintered | 4.9 μm | [symbol] | Both Sides | 950° C. | 165 min. | Polished | 5 | [symbol] | [symbol] |
| | | Magnet | | 6 wt % | | | | | | | |
| Example 3 | [symbol] | Sintered | 4.9 μm | [symbol] | Both Sides | 950° C. | 165 min. | Polished | 10 | [symbol] | [symbol] |
| | | Magnet | | 6 wt % | | | | | | | |
| Example 4 | [symbol] | Sintered | 4.9 μm | [symbol] | Both Sides | 950° C. | 165 min. | Polished | 15 | [symbol] | 1.33 |
| | | Magnet | | 6 wt % | | | | | | | |
| Comparative | [symbol] | Sintered | 4.9 μm | [symbol] | Both Sides | 950° C. | 165 min. | Polished | 20 | 1484 | 1.30 |
| Example 2 | | Magnet | | 6 wt % | | | | | | | |
| Comparative | [symbol] | Sintered | 4.9 μm | [symbol] | Both Sides | 950° C. | 165 min. | Polished | 25 | 1471 | 1.24 |
| Example 3 | | Magnet | | 6 wt % | | | | | | | |
| Comparative | [symbol] | Sintered | 4.9 μm | [symbol] | Both Sides | 950° C. | 165 min. | Polished | 50 | 1406 | 1.24 |
| Example 4 | | Magnet | | 6 wt % | | | | | | | |

[symbol]

indicates data missing or illegible when filed

According to Table 1 and FIG. 2A, it was found that the coercive force drops sharply when the polished region is 20% or more. The larger the polished region level was, the more the residual magnetization tended to drop.

Therefore, the polished region is required to be 15% or less when the effect of the coercive force improvement by the grain boundary diffusion is attempted to be maximized. This is because the grain sizes of the sintered magnets are relatively large, and the polishing of the surface layer eliminates the grains coated by the grain boundary phase. Thus, this part is considered to exhibit a soft magnetic property and to be the source of the magnetization reversal. When the polished region exceeds 15%, the volume fraction of the soft magnetic property region increases, which is considered to contribute to a decrease in the coercive force of the entire magnet.

2. Grain Boundary Diffusion into Sintered Magnet (Difference Between Double-Sided or Single-Sided Diffusion)

### 2-1. Manufacturing of the Rare Earth Magnets

The rare earth magnets were manufactured as follows, based on the description of the method for manufacturing the rare earth magnets described above.

First, for a sintered magnet with a composition of Nd_{11.3}, Pr_{2.7}, Fe_{balance}, Co_{1.1}, B_{5.9}, Ga_{0.4}, Al_{0.2}, Cu_{0.2} (the numbers are in at %, and when all the elements are added together, the number becomes 100 at %), a diffusion material having a composition of Tb₇₀Co₂₀Cu₁₀ (the numbers are in at %, and when all the elements are added together, the number becomes 100 at %) was grain-boundary diffused into the sintered magnet from the C-plane direction (950° C., 165 min.) in an amount of 5 weight % of the total weight of the sintered magnet. In this process, Example 5 had the grain boundary diffusion from both sides, while Comparative Example 5 had the grain boundary diffusion from only one side. Furthermore, in Comparative Example 6, after the double-sided grain boundary diffusion, the entire surface of one side of the C-plane was polished to the extent that the surface layer (residue) of the diffusion material was scraped off.

After the polishing was completed, the magnetic properties were evaluated by VSM. The crystal grain sizes of the magnets (the average grain size of the main phase) were observed by SEM.

### 2-2. Results

Table 2 shows the results of the magnetic property evaluation.

TABLE 2
Table 2 Grain Boundary Diffusion [symbol] nto Sintered Magnet (Difference between Double-Sided or Single-Sided Penetration)

| | Composition | | | | | | | | | | Residual |
|---|---|---|---|---|---|---|---|---|---|---|---|
| | of Base | Magnet | Average | | Both | | | | Polished | Coercive | Magne- |
| | Material | Production | Grain | Diffusion | Sides/ | Diffusion | Diffusion | Polished or | Region | Force | tization |
| | (at %) | Method | Size | Material | One Side | Temperature | Time | Unpolished | (%) | (kA/m) | (T) |
| Example 5 | [symbol] | Sintered | 4.9 μm | [symbol] | Both Sides | 950° C. | 165 min. | Unpolished | 0 | [symbol] | 1.31 |
| | | Magnet | | 5 wt % | | | | | | | |
| Comparative | [symbol] | Sintered | 4.9 μm | [symbol] | One Side | 950° C. | 165 min. | Unpolished | 0 | [symbol] | 1.31 |
| Example 5 | | Magnet | | 5 wt % | | | | | | | |
| Comparative | [symbol] | Sintered | 4.9 μm | [symbol] | Both Sides | 950° C. | 165 min. | Polished | [symbol] | [symbol] | 1.33 |
| Example 6 | | Magnet | | 5 wt % | | | | | | | |

[symbol]

indicates data missing or illegible when filed

According to Table 2, a comparison of Example 5 and Comparative Example 5 shows that the double-sided grain boundary diffusion has a higher coercive force even with the same amount of the grain boundary diffusion. A comparison of Example 5 and Comparative Example 6 also shows that when 50% of the sample with high coercive force is polished (single-sided polishing), the coercive force drops drastically, which is consistent with the results in Table 1. Therefore, it was found that the grain boundary diffusions on both sides, even without the polished region, are a condition for the high coercivity of the magnet.

3. Grain Boundary Diffusion into Hot-Worked Magnet and Polishing Area

### 3-1. Manufacturing of the Rare Earth Magnets

For a hot-worked magnet with a composition of Nd_{13.2}, Fe_{balance}, Co_{19.8}, B_{5.82}, Ga_{0.3}, Al_{0.05}, Cu_{0.09} (the numbers are in at %, and when all the elements are added together, the number becomes 100 at %), a diffusion material having a composition of Nd₈₀Cu₂₀ (the numbers are in at %, and when all the elements are added together, the number becomes 100 at %) was grain-boundary diffused into the hot-worked magnet from the C-plane direction (680° C., 165 min.) in an amount of 10 weight % of the total weight of the hot-worked magnet. After the grain boundary diffusion, a part of the C-plane was polished to the extent that the surface layer (residue) of the diffusion material was scraped off. The polished region was varied from the polished region of 0% (no polishing) to the polished region of 50% (all the surface on one side) as shown in FIG. 1 and Table 3.

After the polishing was completed, the magnetic properties were evaluated by VSM. The crystal grain sizes of the magnets (the average grain size of the main phase) were observed by TEM.

### 3-2. Results

Table 3 and FIG. 2B show the results of the magnetic property evaluation.

TABLE 3
Table 3 Grain Boundary Diffusion [symbol] nto Hot-Worked Magnet and Polishing Area

| | Composition | | | | | | | | | | Residual |
|---|---|---|---|---|---|---|---|---|---|---|---|
| | of Base | Magnet | Average | | Both | Diffusion | | | Polished | Coercive | Magne- |
| | Material | Production | Grain | Diffusion | Sides/ | Temper- | Diffusion | Polished or | Region | Force | tization |
| | (at %) | Method | Size | Material | One Side | ature | Time | Unpolished | (%) | (kA/m) | (T) |
| Comparative | [symbol] | Hot- | 327.5 nm | — | — | — | — | — | — | [symbol] | 1.41 |
| Example 7 | | Worked | | | | | | | | | |
| | | Magnet | | | | | | | | | |
| Comparative | [symbol] | Hot- | 327.5 nm | [symbol] | Both Sides | 680° C. | 165 min. | Unpolished | 0 | 1422 | 1.23 |
| Example 8 | | Worked | | 10 wt % | | | | | | | |
| | | Magnet | | | | | | | | | |
| Comparative | [symbol] | Hot- | 327.5 nm | [symbol] | Both Sides | 680° C. | 165 min. | Polished | 5 | 1410 | 1.20 |
| Example 9 | | Worked | | 10 wt % | | | | | | | |
| | | Magnet | | | | | | | | | |
| Comparative | [symbol] | Hot- | 327.5 nm | [symbol] | Both Sides | 680° C. | 165 min. | Polished | 10 | 1424 | 1.20 |
| Example 10 | | Worked | | 10 wt % | | | | | | | |
| | | Magnet | | | | | | | | | |
| Comparative | [symbol] | Hot- | 327.5 nm | [symbol] | Both Sides | 680° C. | 165 min. | Polished | 15 | 1413 | 1.19 |
| Example 11 | | Worked | | 10 wt % | | | | | | | |
| | | Magnet | | | | | | | | | |
| Comparative | [symbol] | Hot- | 327.5 nm | [symbol] | Both Sides | 680° C. | 165 min. | Polished | 20 | 1420 | 1.20 |
| Example 12 | | Worked | | 10 wt % | | | | | | | |
| | | Magnet | | | | | | | | | |
| Comparative | [symbol] | Hot- | 327.5 nm | [symbol] | Both Sides | 680° C. | 165 min. | Polished | 25 | 1415 | [symbol] |
| Example 13 | | Worked | | 10 wt % | | | | | | | |
| | | Magnet | | | | | | | | | |
| Comparative | [symbol] | Hot- | 327.5 nm | [symbol] | Both Sides | 680° C. | 165 min. | Polished | 50 | 1415 | [symbol] |
| Example 14 | | Worked | | 10 wt % | | | | | | | |
| | | Magnet | | | | | | | | | |

[symbol]

indicates data missing or illegible when filed

Table 3 and FIG. 2B show that the coercive force is constant for the hot-worked magnets, regardless of the polished region. Therefore, it is considered that for the hot-worked magnets with small grain size, the generation of the low coercive force regions (the soft magnetic property regions) by the surface polishing did not affect the coercive force of the entire magnet because the generation of the low coercive force regions (the soft magnetic property regions) by the surface polishing is limited as a volume fraction even when a lot of regions are polished.

### 4. Regarding Volumetric Expansion Rate

The expansion rates before and after the grain boundary diffusion were measured for the magnets of Example 1 and Comparative Example 8. After the grain boundary diffusion, the grain boundary phase becomes thicker and the lattice constant of the 2-14-1 crystal structure of the shell portion changes due to the shell forming effect of the diffusion material. As a result, the magnet basically expands. The expansion rate also changes depending on the type of base material of the magnet, the diffusion material, and the diffusion amount. Table 4 shows the results.

TABLE 4
Table 4 Grain Boundary Diffusion and Expansion Rate

| | Composition | | | | | | | | | | |
|---|---|---|---|---|---|---|---|---|---|---|---|
| | of Base | Magnet | Average | | Both | Diffusion | | | Polished | Change in | Change in |
| | Material | Production | Grain | Diffusion | Sides/ | Temper- | Diffusion | Polished or | Region | a-b Axis | c Axis |
| | (at %) | Method | Size | Material | One Side | ature | Time | Unpolished | (%) | Direction | Direction |
| Example 1 | [symbol] | Sintered | 4.9 μm | [symbol] | Both Sides | 950° C. | 165 min. | Unpolished | 0 | 1.20% | 7.20% |
| | | Magnet | | 6 wt % | | | | | | | |
| Comparative | [symbol] | Hot- | 327.5 nm | [symbol] | Both Sides | 680° C. | 165 min. | Unpolished | 0 | 0.30% | 11.20% |
| Example 8 | | Worked | | 10 wt % | | | | | | | |
| | | Magnet | | | | | | | | | |

[symbol]

indicates data missing or illegible when filed

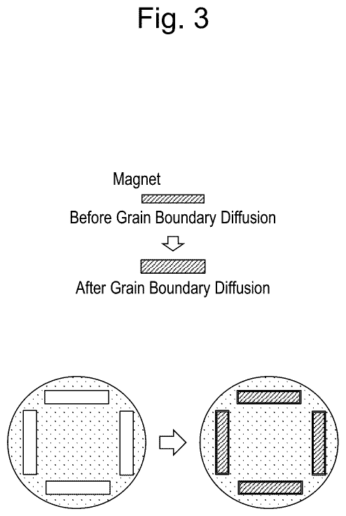

According to Table 4, Example 1 was expanded by 1.2% in an a-b axis direction (in-plane direction) and expanded by 7.2% in a c axis direction (perpendicular to the plane) of the magnet. On the other hand, Comparative Example 8 was expanded by only 0.3% in the a-b axis direction (in-plane direction) and expanded by 11.2% in the c axis direction (perpendicular to the plane). Therefore, by knowing the expansion rate of the magnet after the grain boundary diffusion, it is possible to adjust the magnet dimensions after the grain boundary diffusion, for example, as shown in FIG. 3, by manufacturing a base material magnet to be small by the aforementioned expansion in advance in order to slot the magnets into the rotor. It was found that this allows the magnet of a predetermined size to be slotted into the rotor without polishing and without causing an extra gap to occur.

### 5. Regarding Polishing Depth

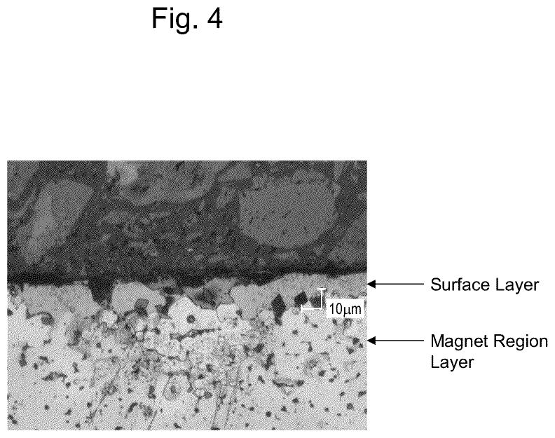

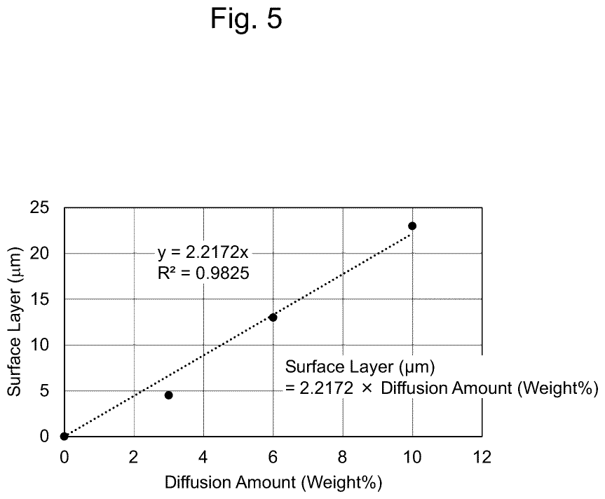

The thickness of the surface layer formed of the diffusion material remaining on the surface was measured for the magnets in Table 1. FIG. 4 shows a SEM photograph of the magnet region layer and the surface layer in the unpolished portion of the magnet of Example 1, and Table 5 and FIG. 5 show the results.

TABLE 5
Table 5 Penetration Amount of Diffusion Material and Layer Thickness of Surface Layer

| | Composition | | | | | | | | | |
|---|---|---|---|---|---|---|---|---|---|---|
| | of Base | Magnet | Average | | Both | | | | Polished | Surface |
| | Material | Production | Grain | Diffusion | Sides/ | Diffusion | Diffusion | Polished or | Region | Layer |
| | (at %) | Method | Size | Material | One Side | Temperature | Time | Unpolished | (%) | (μm) |
| Example [symbol] | [symbol] | Sintered | 4.9 μm | [symbol] | Both Sides | 950° C. | 165 min. | Unpolished | 0 | [symbol] |
| | | Magnet | | 3 wt % | | | | | | |
| Example 1 | [symbol] | Sintered | 4.9 μm | [symbol] | Both Sides | 950° C. | 165 min. | Unpolished | 0 | 13 |
| | | Magnet | | 6 wt % | | | | | | |
| Example 7 | [symbol] | Sintered | 4.9 μm | [symbol] | Both Sides | 950° C. | 165 min. | Unpolished | 0 | 23 |
| | | Magnet | | 10 wt % | | | | | | |

[symbol]

indicates data missing or illegible when filed

According to FIGS. 4 and 5, it was found that the increased use amount of the diffusion material tends to increase the thickness of the layer remaining on the surface, and at about 6 weight % by weight in this Example 1, it is about 13 μm. This experiment revealed that the following approximate relationship holds: Surface layer (μm)=2.2172×Use amount of the diffusion material (weight %).

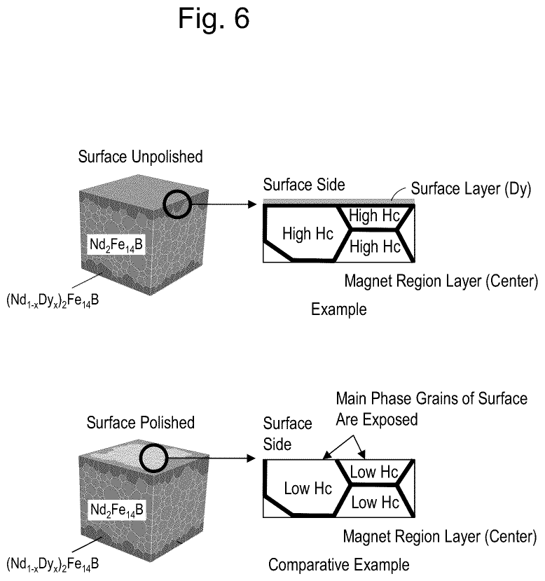

FIG. 6 schematically illustrates the differences between the magnets of Example and Comparative Example in this experiment. In Example, 85% or more of the C-plane of the magnet region layer of the magnet is covered by the surface layer, thus maintaining the high coercive force. On the other hand, in Comparative Example, 20% or more of the C-plane of the magnet region layer of the magnet is not covered by the surface layer, leaving the main phase exposed, resulting in the lower coercive force.

All publications, patents and patent applications cited in the present description are herein incorporated by reference as they are.

What is claimed is:

1. An R-T-B-based rare earth magnet in which R is a rare earth element, T is Fe and/or Co, and B is boron, the R-T-B-based rare earth magnet comprising:
a magnet region layer; and
a surface layer covering a C-plane of the magnet region layer,
wherein the magnet region layer includes a main phase having an R₂T₁₄B-type crystal structure and a grain boundary phase present around the main phase,
wherein the main phase has an average grain size from 1.0 μm to 10.0 μm,
wherein the surface layer covers 85% or more of the C-plane of the magnet region layer with respect to a total area of the C-plane.

2. The R-T-B-based rare earth magnet according to claim 1,
wherein the main phase includes a core portion and a shell portion present around the core portion, and
a total content ratio of Nd, Pr, Tb, Dy, and Ho to a total of constituent elements of the shell portion in the shell portion is higher than a total content ratio of Nd, Pr, Tb, Dy, and Ho to a total of constituent elements of the core portion in the core portion.

3. The R-T-B-based rare earth magnet according to claim 1,
wherein a composition of the surface layer and the grain boundary phase is represented by Formula of R²₍₁₋ₛ₎M²ₛ (in the formula, R² is one or more elements selected from the group consisting of Nd, Pr, Gd, Tb, Dy, Ce, La, and Ho, M² is a metallic element other than rare earth elements and allowed to be alloyed with R² and an unavoidable impurity elements, and (1-s) and s are molar ratios where 0.05≤s≤0.40).

4. The R-T-B-based rare earth magnet according to claim 1,
wherein a rare earth concentration of the surface layer is higher than a rare earth concentration of the magnet region layer.

5. A motor comprising:
a stator core including a coil; and
a rotor core rotatable in a hollow portion of the stator core,
wherein the rotor core includes the R-T-B-based rare earth magnet according to claim 1.

6. A method for manufacturing an R-T-B-based rare earth magnet in which R is a rare earth element, T is Fe and/or Co, and B is boron, the method comprising
preparing a diffusion material penetrated rare earth magnet precursor having a magnet region layer and a surface layer covering a C-plane of the magnet region layer by diffusive penetration of a diffusion material into a rare earth magnet precursor; and
manufacturing an R-T-B-based rare earth magnet by polishing the diffusion material penetrated rare earth magnet precursor,
wherein in the preparing, the diffusion material is represented by Formula of R²₍₁₋ₛ₎M²ₛ (in the formula, R² is one or more elements selected from the group consisting of Nd, Pr, Gd, Tb, Dy, Ce, La, and Ho, M² is a metallic element other than rare earth elements and allowed to be alloyed with R² and an unavoidable impurity elements, and (1-s) and s are molar ratios where 0.05≤s≤0.40), the diffusion material penetrated rare earth magnet precursor includes a main phase having an R₂T₁₄B-type crystal structure and a grain boundary phase present around the main phase, and the main phase has an average grain size from 1.0 μm to 10.0 μm, and
wherein in the manufacturing, the surface layer present on the C-plane of the diffusion material penetrated rare earth magnet precursor is polished such that 85% or more of a total area of the C-plane of the diffusion material penetrated rare earth magnet precursor remains.

7. A method for manufacturing an R-T-B-based rare earth magnet in which R is a rare earth element, T is Fe and/or Co, and B is boron, the method comprising preparing a diffusion material penetrated rare earth magnet precursor having a magnet region layer and a surface layer covering a C-plane of the magnet region layer by diffusive penetration of a diffusion material into a rare earth magnet precursor; and
manufacturing an R-T-B-based rare earth magnet by polishing the diffusion material penetrated rare earth magnet precursor,
wherein in the preparing, the diffusion material is represented by Formula of R²₍₁₋ₛ₎M²ₛ (in the formula, R² is one or more elements selected from the group consisting of Nd, Pr, Gd, Tb, Dy, Ce, La, and Ho, M² is a metallic element other than rare earth elements and allowed to be alloyed with R² and an unavoidable impurity elements, and (1-s) and s are molar ratios where 0.05≤s≤0.40), the diffusion material penetrated rare earth magnet precursor includes a main phase having an R₂T₁₄B-type crystal structure and a grain boundary phase present around the main phase, and the main phase has an average grain size from 1.0 μm to 10.0 μm, and
wherein in the manufacturing, the diffusion material penetrated rare earth magnet precursor is polished to less than a thickness of the surface layer expressed by a following formula of use amount of the diffusion material (amount of diffusion material to a total weight of the rare earth magnet precursor (weight %))×2.2172.
